(19) United States
(12) Patent Application Publication
(10) Pub. No.: US 2018/0032299 A1
(43) Pub. Date: Feb. 1, 2018

(54) PAIRING SYSTEM AND PAIRING METHOD FOR DISPLAY DEVICES AND MULTI-MEDIA DEVICES

(71) Applicant: IADEA CORPORATION, Taipei City (TW)

(72) Inventors: Chi-Fu Liu, New Taipei City (TW); Yung-Tsai Wang, Taoyuan City (TW); Chia-Chin Wang, Taipei City (TW)

(21) Appl. No.: 15/222,965

(22) Filed: Jul. 29, 2016

(51) Int. Cl. G06F 3/147; H04W 76/02

(52) U.S. Cl. CPC G06F 3/147; H04W 76/021; H04W 76/023

(57) ABSTRACT

The present invention provides a pairing system and a pairing method for a plurality of display devices and a plurality of multi-media devices that can make the pairing process between the plurality of display devices and the plurality of multi-media devices more convenient and easier for users. The pairing system comprises: a plurality of multi-media devices and a control device. The plurality of multi-media devices are respectively coupled to the plurality of display devices, and utilized for transmitting signals to the plurality of display devices, respectively. The control device is utilized for automatically pairing the plurality of display devices with the plurality of multi-media devices. The pairing method comprises: utilizing a control device to automatically pair the plurality of display devices with the plurality of multi-media devices by controlling the plurality of multi-media devices to transmit a plurality of identifying signals to the plurality of display devices.

### BACKGROUND OF THE INVENTION

### 1. Field of the Invention

The present invention relates to a pairing system and a pairing method, and more particularly, to a pairing system and a pairing method for a plurality of display devices and a plurality of multi-media devices that can make the pairing process between the plurality of display devices and the plurality of multi-media devices more convenient and easier for users.

### 2. Description of the Prior Art

In general, the conventional pairing method for a plurality of display devices and a plurality of multi-media devices requires users to remember the settings and the relations between the plurality of display devices and the plurality of multi-media devices to perform the pairing process. However, when the multi-media devices are replaced by other multi-media devices, or the number of the display devices or the multi-media devices is changed, or the number of the display devices and the multi-media devices is very large (for example, a large television wall), it is very difficult for the users to remember the settings and the relations between the display devices and the multi-media devices to perform the pairing process.

### SUMMARY OF THE INVENTION

It is therefore one of the objectives of the present invention to provide a pairing system and a pairing method for a plurality of display devices and a plurality of multi-media devices that can make the pairing process between the plurality of display devices and the plurality of multi-media devices more convenient and easier for users, so as to solve the above problem.

In accordance with an embodiment of the present invention, a pairing system for a plurality of display devices is disclosed. The pairing system comprises: a plurality of multi-media devices and a control device. The plurality of multi-media devices are respectively coupled to the plurality of display devices, and utilized for transmitting signals to the plurality of display devices, respectively. The control device is utilized for automatically pairing the plurality of display devices with the plurality of multi-media devices.

In accordance with an embodiment of the present invention, a pairing method for a plurality of display devices and a plurality of multi-media devices is disclosed. The pairing method comprises: utilizing a control device to automatically pair the plurality of display devices with the plurality of multi-media devices by controlling the plurality of multi-media devices to transmit a plurality of identifying signals to the plurality of display devices.

Briefly summarized, the pairing system and the pairing method disclosed by the present invention can make the pairing process between a plurality of display devices and a plurality of multi-media devices (such as a television wall) more convenient and easier for the users. More particularly, when the multi-media devices are replaced by other multi-media devices, or the number of the display devices or the multi-media devices is changed, or the number of the display devices and the multi-media devices is very large (for example, a large television wall), the pairing system and the pairing method disclosed by the present invention will have more advantages in comparison with the prior art since it is very difficult for the users to remember the settings and the relations between the display devices and the multi-media devices to perform the pairing process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a pairing system for a plurality of display devices in accordance with an embodiment of the present invention.

FIG. 2 shows a simplified diagram of a control software interface of the control device in the pairing system in FIG. 1 in accordance with an embodiment of the present invention.

FIG. 3 shows a simplified diagram of a control software interface of the control device in the pairing system in FIG. 1 in accordance with an embodiment of the present invention.

FIG. 4 shows a simplified diagram of a control software interface of the control device in the pairing system in FIG. 1 in accordance with an embodiment of the present invention.

FIG. 5 shows a simplified diagram of a control software interface of the control device in the pairing system in FIG. 1 in accordance with an embodiment of the present invention.

FIG. 6 shows a simplified diagram of a control software interface of the control device in the pairing system in FIG. 1 in accordance with an embodiment of the present invention.

FIG. 7 is a flowchart showing a pairing method for a plurality of display devices and a plurality of multi-media devices of an embodiment in accordance with the operation schemes of the pairing system in FIG. 1 of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . .”The terms “couple” and “coupled” are intended to mean either an indirect or a direct electrical connection. Thus, if a first device couples to a second device, that connection may be through a direct electrical connection, or through an indirect electrical connection via other devices and connections.

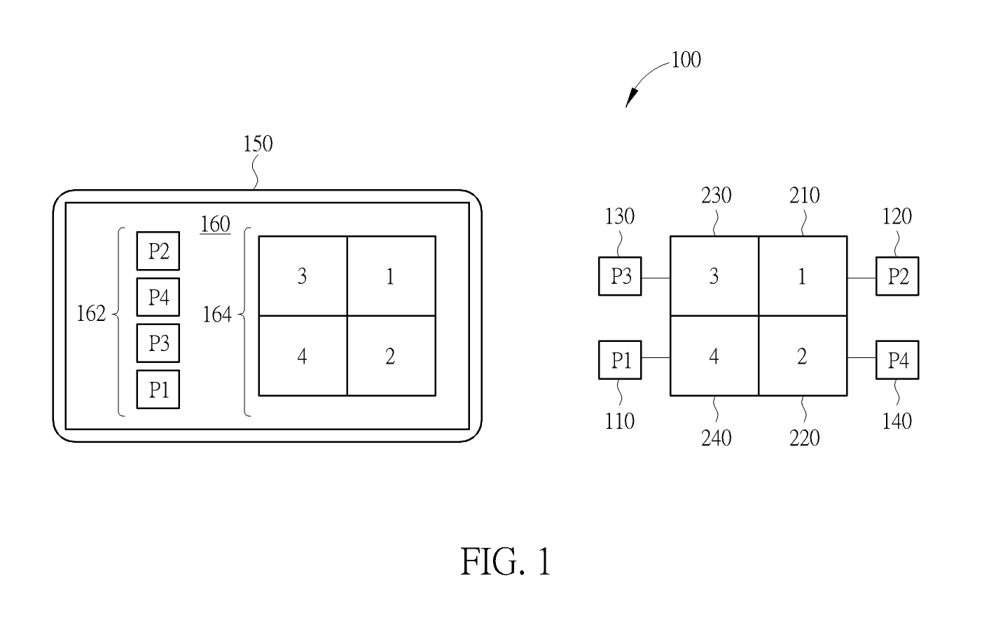

Please refer to FIG. 1. FIG. 1 shows a simplified block diagram of a pairing system 100 for a plurality of display devices in accordance with an embodiment of the present invention, wherein there are four display devices 210, 220, 230, 240 in this embodiment, and the display devices 210, 220, 230, 240 constitute a television wall. As shown in FIG. 1, the pairing system 100 comprises: four multi-media devices 110, 120, 130, 140, and a control device 150, wherein the control device 150 can be an electronic device (such as a smartphone, a tablet, a multi-media device, or a notebook computer) having a control software, and the multi-media devices 120, 140, 130, 110 can be multi-media players. The multi-media devices 120, 140, 130, 110 are respectively coupled to the display devices 210, 220, 230, 240, and utilized for transmitting signals to the display devices 210, 220, 230, 240, respectively. The control device 150 is utilized for automatically pairing the display devices 210, 220, 230, 240 with the multi-media devices 120, 140, 130, 110 by controlling the multi-media devices 120, 140, 130, 110 to transmit a plurality of identifying signals to the display devices 210, 220, 230, 240.

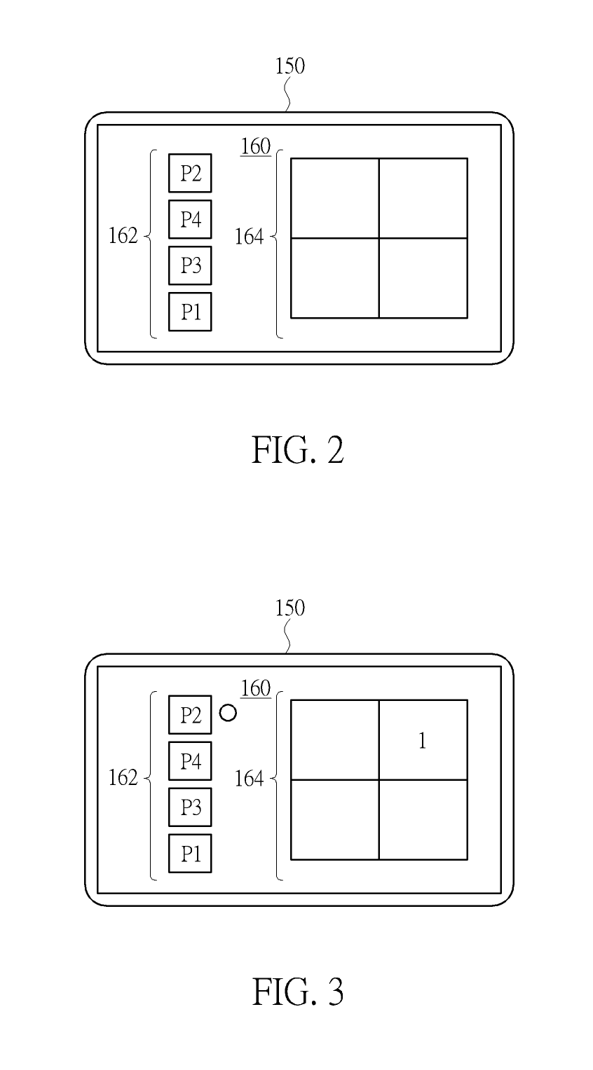

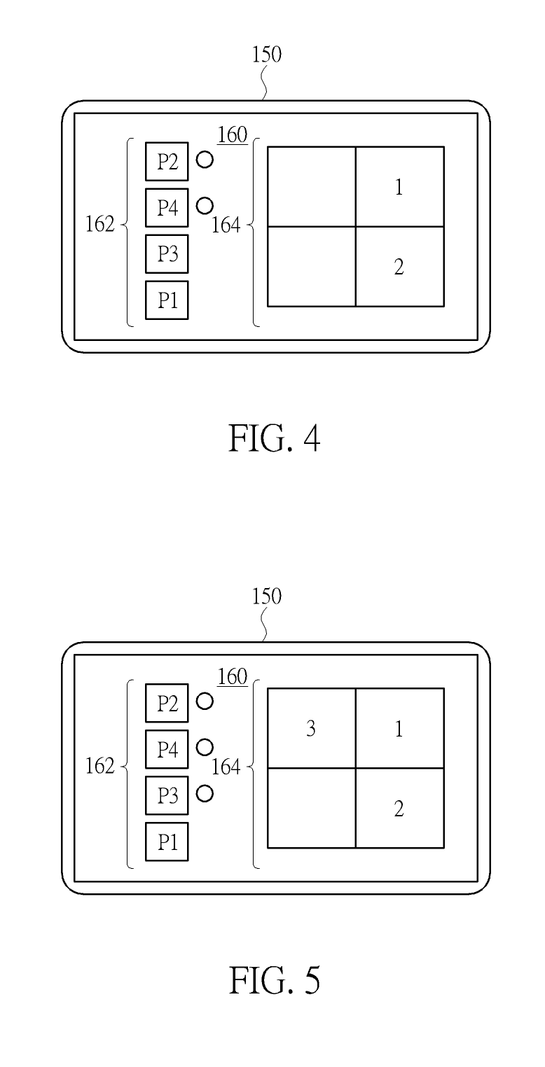

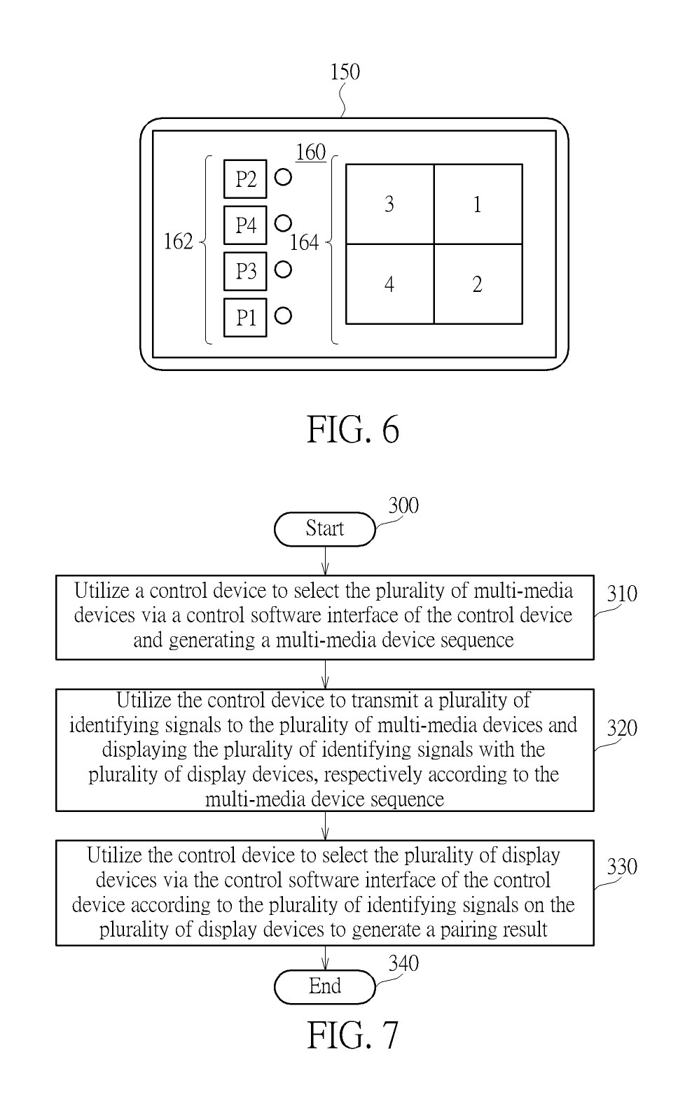

For example, when a user uses the control device 150 to automatically pair the display devices 210, 220, 230, 240 with the multi-media devices 120, 140, 130, 110, the user can select the multi-media devices 120, 140, 130, 110 via a control software interface 160 of the control device 150 and generating a multi-media device sequence 162 shown in FIG. 2, and then the control device 150 transmit four identifying signals 1, 2, 3, 4 to the multi-media devices 120, 140, 130, 110 and respectively displaying the identifying signals 1, 2, 3, 4 with the display devices 210, 220, 230, 240 according to the multi-media device sequence 162 shown in FIG. 1, wherein the multi-media devices 120, 140, 130, 110 can further transmit the identifying signals 1, 2, 3, 4 to the display devices 210, 220, 230, 240 and respectively displaying the identifying signals 1, 2, 3, 4 with the display devices 210, 220, 230, 240 according to a table in a database of a control software in the control device 150. Next, the user can select the display devices 210, 220, 230, 240 via display device blocks 164 of the control software interface 160 of the control device 150 according to the plurality of identifying signals 1, 2, 3, 4 on the multi-media devices 120, 140, 130, 110 to generate a pairing result shown in FIGS. 3-6. Specifically, when the user touches or presses the device block 164 showing the identifying signals 1 shown in FIG. 3, the control software of the control device 150 will record that the multi-media devices 120 is paired with the display devices 210. When the user touches or presses the device block 164 showing the identifying signals 2 shown in FIG. 4, the control software of the control device 150 will record that the multi-media devices 140 is paired with the display devices 220. When the user touches or presses the device block 164 showing the identifying signals 3 shown in FIG. 5, the control software of the control device 150 will record that the multi-media devices 130 is paired with the display devices 230. When the user touches or presses the device block 164 showing the identifying signals 4 shown in FIG. 5, the control software of the control device 150 will record that the multi-media devices 110 is paired with the display devices 240. In addition, please note that the multi-media devices 120, 140, 130, 110 also can have control softwares related to the control software of the control device 150.

In this way, the user can finish the pairing process of pairing the display devices 210, 220, 230, 240 with the multi-media devices 120, 140, 130, 110 by utilizing the pairing system 100 of the present invention. In addition, the user can further using the control device 150 to generate corresponding content signals to the multi-media devices 120, 140, 130, 110 for displaying corresponding contents (such as texts, pictures, videos, commercials, or advertisements) on the multi-media devices 120, 140, 130, 110 according to the pairing result. Please note that the above embodiment is only for an illustrative purpose and is not meant to be a limitation of the present invention. For example, the number of the multi-media devices and the number of the display devices are not meant to be limitations of the present invention, and the number of the multi-media devices and the number of the display devices can be changed according to different design requirements.

Please refer to FIG. 7. FIG. 7 is a flowchart showing a pairing method for a plurality of display devices and a plurality of multi-media devices of an embodiment in accordance with the above operation schemes of the pairing system 100 in FIG. 1 of the present invention. Provided that substantially the same result is achieved, the steps of the process flowchart need not be in the exact order shown in FIG. 7 and need not be contiguous, that is, other steps can be intermediate. The pairing method in the third embodiment of the present invention comprises the following steps:

Step 300: Start.

Step 310: Utilize a control device to select the plurality of multi-media devices via a control software interface of the control device and generating a multi-media device sequence.

Step 320: Utilize the control device to transmit a plurality of identifying signals to the plurality of multi-media devices and displaying the plurality of identifying signals with the plurality of display devices, respectively according to the multi-media device sequence.

Step 330: Utilize the control device to select the plurality of display devices via the control software interface of the control device according to the plurality of identifying signals on the plurality of display devices to generate a pairing result.

Step 340: End.

In addition, in the Step 320, the plurality of multi-media devices can further transmit the identifying signals to the display devices and respectively displays the identifying signals with the display devices according to a table in a database of a control software in the control device. Please note that the above embodiment is only for an illustrative purpose and is not meant to be a limitation of the present invention. For example, the pairing method can further comprise: utilizing the control device to generate corresponding content signals to the plurality of multi-media devices for displaying corresponding contents on the plurality of display devices according to the pairing result.

Briefly summarized, the pairing system and the pairing method disclosed by the present invention can make the pairing process between a plurality of display devices and a plurality of multi-media devices (such as a television wall) more convenient and easier for the users. More particularly, when the multi-media devices are replaced by other multi-media devices, or the number of the display devices or the multi-media devices is changed, or the number of the display devices and the multi-media devices is very large (for example, a large television wall), the pairing system and the pairing method disclosed by the present invention will have more advantages in comparison with the prior art since it is very difficult for the users to remember the settings and the relations between the display devices and the multi-media devices to perform the pairing process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pairing system for a plurality of display devices, comprising:
a plurality of multi-media devices, respectively coupled to the plurality of display devices, for transmitting signals to the plurality of display devices, respectively; and
a control device, for automatically pairing the plurality of display devices with the plurality of multi-media devices by controlling the plurality of multi-media devices to transmit a plurality of identifying signals to the plurality of display devices.

2. The pairing system of claim 1, wherein the function of the control device of automatically pairing the plurality of display devices with the plurality of multi-media devices comprises:
selecting the plurality of multi-media devices via a control software interface of the control device and generating a multi-media device sequence;
transmitting the plurality of identifying signals to the plurality of multi-media devices and displaying the plurality of identifying signals with the plurality of display devices, respectively according to the multi-media device sequence;
selecting the plurality of display devices via the control software interface of the control device according to the plurality of identifying signals on the plurality of display devices to generate a pairing result.

3. The pairing system of claim 2, wherein the multi-media devices further transmit the identifying signals to the display devices and respectively displays the identifying signals with the display devices according to a table in a database of a control software in the control device.

4. The pairing system of claim 2, wherein the control device further generate corresponding content signals to the plurality of multi-media devices for displaying corresponding contents on the plurality of display devices according to the pairing result.

5. The pairing system of claim 1, wherein the control device is an electronic device having a control software.

6. The pairing system of claim 1, wherein the multi-media devices are multi-media players having a control software.

7. A pairing method for a plurality of display devices and a plurality of multi-media devices, the pairing method comprising:
utilizing a control device to automatically pair the plurality of display devices with the plurality of multi-media devices by controlling the plurality of multi-media devices to transmit a plurality of identifying signals to the plurality of display devices.

8. The pairing method of claim 1, wherein the step of utilizing the control device to automatically pair the plurality of display devices with the plurality of multi-media devices comprises:
selecting the plurality of multi-media devices via a control software interface of the control device and generating a multi-media device sequence;
transmitting a plurality of identifying signals to the plurality of multi-media devices and displaying the plurality of identifying signals with the plurality of display devices, respectively according to the multi-media device sequence;
selecting the plurality of display devices via the control software interface of the control device according to the plurality of identifying signals on the plurality of display devices to generate a pairing result.

9. The pairing method of claim 8, wherein the multi-media devices further transmit the identifying signals to the display devices and respectively displays the identifying signals with the display devices according to a table in a database of a control software in the control device.

10. The pairing method of claim 8, further comprising:
utilizing the control device to generate corresponding content signals to the plurality of multi-media devices for displaying corresponding contents on the plurality of display devices according to the pairing result.
